(19) United States
(12) Patent Application Publication
(10) Pub. No.: US 2012/0101980 A1
(43) Pub. Date: Apr. 26, 2012

(54) SYNCHRONIZING ONLINE DOCUMENT EDITS

(75) Inventors: Ali Taleghani, Redmond, WA (US); Tristan Davis, Seattle, WA (US)

(73) Assignee: MICROSOFT CORPORATION, Redmond, WA (US)

(21) Appl. No.: 13/015,816

(22) Filed: Jan. 28, 2011

Related U.S. Application Data
(60) Provisional application No. 61/406,942, filed on Oct. 26, 2010.

(51) Int. Cl. G06F 17/30

(52) U.S. Cl. 707/608; 707/E17.008

(57) ABSTRACT

Online documents services are provided by application servers for editing by users. Documents are stored in component based structures in an application server's local memory to provide granularity in coauthoring and conflict resolution. Component level locking is utilized to minimize simultaneous user edit based conflicts and also to show presence of other users. Component based structure revisions are stored to capture component edits and synchronize upon document save actions. When edits are saved by one or more clients to the server, they can be saved to the current version of the server document, even if that document has changed from the version used to create the current representation on the client.

### CROSS REFERENCE TO RELATED APPLICATIONS

This application claims the benefit of U.S. Provisional Patent Application Ser. No. 61/406,942 filed on Oct. 26, 2010. The disclosures of the provisional patent application are hereby incorporated by reference for all purposes.

### BACKGROUND

Web applications provide a wide variety of services and data to users over networks. Data is collected, processed, and stored in different locations. Web applications retrieve that data, format it for presentation, and provide it to browsing applications on client devices for rendering web pages. Some web pages may be static, where the data is non-interactive. Others may provide some interactivity such as additional information through links or activation of web-based modules. In general, however, web pages present data in a format and amount that is decided by the web page author.

Online document applications provide users with document editing and viewing capabilities that were only the realm of thick client application until recently. Technological advances in computing and expansion in network and data storage capacities have enabled online applications to provide document editing features of thick client applications. Advantages in availability of online applications across various platforms independent of underlying technologies have enabled a multitude of users to collaborate on document creation and management. However, access to a document by multiple users may lead to asynchronous user edits. Providing access to a document across multiple platforms through a variety of technologies may further complicate document maintenance and document coherency.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to synchronizing online document edits by controlling revisions at document component level. According to some embodiments, a document may be transformed to a graph of document components and locks may be asserted on the components to manage changes submitted by multiple users. Changes in graph components may be tracked by maintaining revisions of the graph.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram illustrating example components of an online document editing service;

FIG. 2 illustrates example steps in locking actions to manage edits;

FIG. 3 illustrates example steps in revision implementation to manage edits;

FIG. 4A through 4C illustrate an example scenario according to some embodiments;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of synchronizing online document edits by controlling revisions at document component level according to embodiments.

### DETAILED DESCRIPTION

As briefly described above, online document edits may be synchronized by controlling revisions at document component level by using locking actions. A document may be transformed to a graph of document components. Locks may be asserted on the components to manage changes submitted by multiple users. Changes in graph components may be tracked by maintaining revisions of the graph to include edits at component levels of the document for each co-author's edits. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable storage media.

Throughout this specification, the term “platform” may be a combination of software and hardware components for providing coauthoring services for various document types or similar environment, where embodiments may be implemented. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

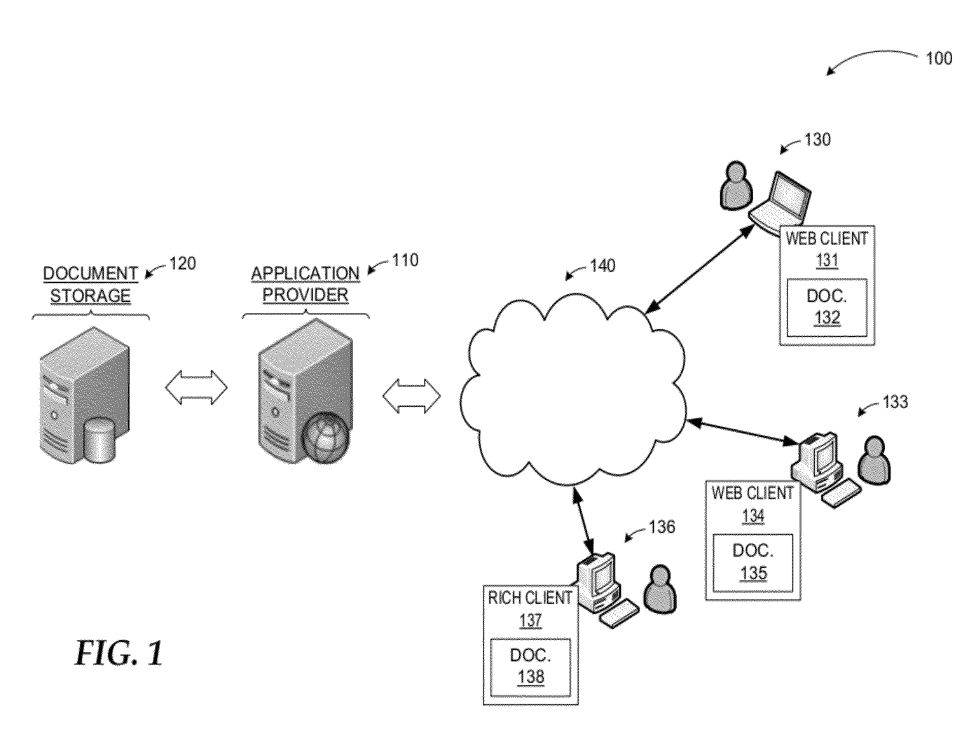

FIG. 1 is a diagram illustrating example components of an online document editing service. In diagram 100, the servers 110 may execute one or more online document editing applications and transmit document content, among other information, via network 140. The network 140 may be a local network or may be an external entity such as an internet based infrastructure. It may provide wired or wireless connectivity. Network nodes may connect to each other through unsecured or secured connectivity. An example of a secured connectivity may be a Virtual Private Network (VPN) established among the network nodes with the use of encrypted communications.

The servers 110 may provide a document editing application communicating with clients through a variety of protocols, an example of which may be the Hyper Text Transport Protocol (HTTP). The application may provide document editing services to end users on thin and thick clients. Thin clients (or web clients) 131, 134 may be dependent on server application provided features. Thick clients (or rich clients) 137 may combine server application provided features with local features to provide additional utility to end users. Rich clients 137 are not required to connect to the same application server 110. Ultimately, all clients are editing the same document on 120. According to some implementations, the application server 110 may be one that is suited to web editing capabilities and another server may provide the services that are suited to and used by the rich clients 137. An example of application services may be integrating user edits with user presence information and user's name to display user changes on client devices. Additionally, server application may enable multiple users to access services through different client devices (130, 133, and 136). In an example scenario, users may access and modify a document resulting in different versions of the same document (132, 135, and 138).

In an embodiment, the document server 120 may be a document storage service. The document may store documents of variety of types and formats including, but not exclusive to, text, drawings, images, video, and audio. In an example system, document server may store text documents that are edited by multiple users through online editing applications provided by the application server. In another example system, document server may store image documents accessed and edited by multiple users through online image editing applications provided by the application server. Yet, in other examples, document storage server may provide multiple file type and formats simultaneously for access and editing through hybrid document type online application services to multiple users.

In an example scenario, a user may access an existing document for editing through a document application provided by the application server. Upon user request, the application server may retrieve and lock the document in the storage server. The application server may transform the document to a graph encapsulating the components of the document. The application server may assign the graph a revision number. The application may evaluate the user changes and alter the document lock to component lock(s) covering the graph components containing the changed components. The application server may write the changes to graph components, change the revision number of the graph, and may synchronize the graph changes by writing to the file server. Additionally, an offline client may transmit edits for integration into the graph after coming back online.

An application server enabling users to coauthor documents may expect certain communications from clients. The communications may come in the form of two kinds of requests: storage requests and server access requests. The request operations may be implemented using two layers. First, the server may expose Simple Object Access Protocol (SOAP) interfaces for each request. The requests then may be passed on to a component of the server front-end servicing the request.

In another example embodiment, a web browser based client application may be composed of two parts, a script-based code running in the browser and the implementation specific code, such as C# code, running on the front-end. The front-end may be receiving and servicing the requests. As a result, the application may have an option in implementing how the web browser based client may be making its requests. The code running in the browser may: 1) make requests directly to the exposed SOAP interfaces on the server, or 2) make all requests directly to a single entry point on the server, and upon receiving the SOAP request, have the front-end invoke the component that may service the request directly from within the front-end.

Making all requests directly to a single entry point on the server may have advantages in pre-processing, post-processing, manageability, portability, and consistency. For pre-processing, an Asynchronous Java Script (AJAX) or similar request may contain a binary stream which may contain the details of the operation being requested of the server. Creating the binary stream may be cumbersome in the script language. Additionally, the server may already have access to utilities that may create the binary request from simpler instructions.

For post-processing, some processing may be desirable to transform the raw response to a more interpretable format for the browser beyond binary streams. The response may contain data that may refer to the document. For manageability, utilizing a single entry point, the system may implement operations such as throttling to consider the true load on the front-end. The application may also better reuse state when multiple related requests arrive at the same time. For portability, having the browser make calls to various end points, the system may add burden to other implementers by forcing them to keep the names of the end-points from implementation to implementation. For consistency, the browser based document editor may funnel most communication through the same end-point.

In another embodiment, storage requests may be used to store or retrieve data. These storage requests may be made against one or more partitioned data cells tied to the underlying document. Making storage requests from the client application such as a web browser to the server front-end may be accomplished through different mechanisms. However, users coauthoring documents may require additional requests to store and retrieve metadata relevant to coauthoring, which may impose new requirements on the system.

In an example, a web browser may perform an operation to retrieve the contents of a page. The browser may make a web browser based service call to the document. The browser may instantiate and fill in its response object with the data about which document and which cell it may wish to target and issue the request.

When the server receives the request, the application may switch based on type (after throttling, batching) and dispatch to an appropriate handler based on the type. The application may transform the input to a format acceptable to an end-point based on implemented technology. The protocol may accept inputs for its requests only in a binary stream, or convert any inputs to binary data (in order to maximize the efficiency of storing such data). A function may take a stream as input which may be the parameter containing the specifics of the request (get or put, which partition, which cell) that the application may execute.

In another example embodiment, a component on the application provider (110) may contain objects that may build the binary stream from arguments. It may be prudent to implement a wrapper to interoperate in between such technology implementations.

The wrapper may wrap native facilities and expose them to the implementation code. A wrapper implementation object may exist for each type of request made to the browser based service (such as retrieving data for a particular cell). The object may be instantiated with the same arguments available on the browser based service request. The object may implement an AddToNativeRequest method that is aware of how to invoke a method on an implementation of the native facility executing the request. Finally, an Execute method may be invoked on the interface executing the request and returning the result (i.e.: a stream). The result may be transformed back to object-oriented structures within the wrapper code. Requests storing or retrieving cell data may be serviced as browser based applications using the wrapper for document content.

The application may adapt the wrapper interaction for use in storing and retrieving the metadata for coauthoring. However, the metadata may not be expressed in terms of cell objects. The metadata to be stored by the application may be opaque blobs of data such as extensible markup language (XML) documents. The metadata may be broken into a graph of cell objects to store in terms of cells. Upon retrieval, the data may come back as a graph of cell objects which may be reconstituted to a stream.

The application code on the application server may handle the metadata storage requests by storing or retrieving the data as streams. The streams may be fed to XML document objects for manipulation according to the appropriate schema.

In yet another embodiment, server access requests may be limited to a set of requests performing functionality such as joining/leaving the coauthoring session. The functionality may ask for information about the currently authenticated user (such as name, email address, and other user information). Such requests may be named coauthoring requests. The server requests may follow the same pattern as storage requests. An object may be capable of creating coauthoring requests using friendly arguments. The parameters and outputs for server requests may be simpler and much smaller burden than the cost of creating a binary stream required for storage requests.

Example embodiments are illustrated herein with specific protocols, commands, messages, and systems. These are not to be construed as limitations on embodiments, however. Different aspects of the present disclosure may be implemented with other programming languages, protocols, systems, and components using the principles described herein,

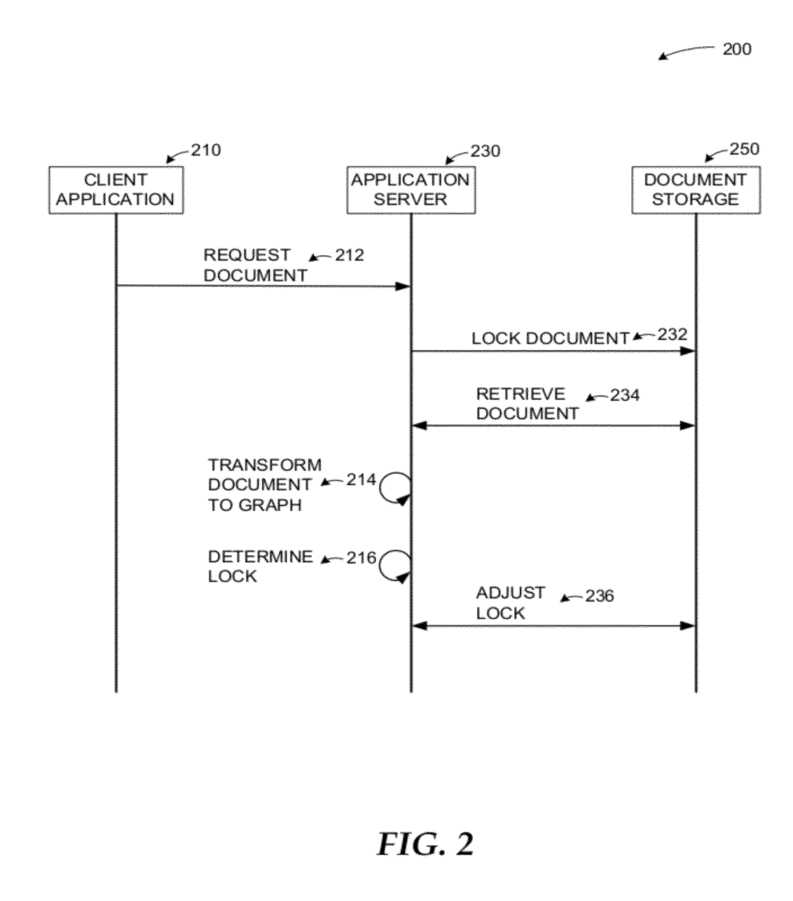

FIG. 2 illustrates example steps in locking actions to manage access to a document. Diagram 200 illustrates some example steps in locking actions to manage edits according to embodiments. Client application 210 such as a web browser may request a document (212) from application server 230. Upon receiving the request the application server may transmit a lock request (232) to document storage server 250 to create a document lock on the requested document. Upon creating the document lock, the application server may retrieve the document (234) from the storage server.

According to some embodiments, the server may first acquire a lock on the document, then inspect it to ensure that it is suitable for coauthoring (216), and once it has made this determination, it may adjust the lock to one that allows multiple clients to open the document (236). If the lock is determined to be unsuitable, the server may change back to an exclusive lock. This allows the server to hold documents whose complexity makes them unsuitable for coauthoring alongside documents that are suitable for such actions without any prior knowledge of the content of the documents, which might fall out of synchronization with the document content and be wrong.

An example embodiment may be an XML document hosting text. The application server may parse the XML document to its schema and paragraph components and store the components in a graph while giving the graph a revision number. Responses to storage requests may be in the form of streams. Streams may need to be parsed into an XML document or alternatively into a simple API for XML to avoid a memory burden. XML elements specifying properties may become constructs with member variables. The responses from the server access requests may have more specific structure and may be directly translated to browser friendly terms.

In an alternate embodiment, a more complicated post-processing step may result in significant performance gains on a thin client application such as a web browser at the cost of having the server do the work. A secondary metadata may contain descriptions of locks and for each lock and a list of paragraph identifiers of the paragraph covered by the lock. The browser may need to traverse the graph looking for paragraphs whose identifiers are specified by the lock to apply each lock to the covered paragraphs.

Alternatively, the lock specification may contain the object identifiers of the paragraph objects instead of the corresponding paragraph identifiers. Asking for an object by its identifier in the graph is effectively random access, and the application may avoid a whole traversal.

The server front-end responding to a request for secondary metadata may have enough information to respond with locks specifying object identifiers of the covered paragraphs instead of paragraph identifiers. Upon retrieving the secondary metadata, the server front-end may parse out he locks then retrieve the most recent revision of the graph from storage on the application server. The server front-end may follow by finding all paragraph objects in the graph, building a reverse map from the paragraph identifier to object identifier of the paragraph object. The server front-end may build a response containing paragraph object identifiers in place of paragraph identifiers.

On the browser side, a design may include the following objects with the common Actor/Editor/Manager pattern for interpreting and acting on coauthoring metadata and replicators for moving metadata:
1. Editor's Table
   A process to periodically download the editors table and upload (twice in session)
   An editor encapsulating the knowledge of the editors table schema
   A manager maintaining an in-memory structure representing the coauthors currently in the document. The manager may expose Add and Remove methods that are called by the editor as it interprets the data. The manager may also expose a look-up method to find a user by his/her GUID identifier.
   An actor dealing with any UI which may also be providing other functionality such as Instant Messaging and others.
2. Secondary Metadata
   A process to periodically download and upload the secondary metadata.

The secondary metadata may contain a few pieces of information, primarily information about in-document locks. The information in the secondary metadata, other than in-document locks, may be managed in the replicator. For locks, an Actor/Editor/Manager pattern may be deployed again:
1. An actor with methods to add and remove locks to give components of the graph. The actor may also have a method to answer the “can I type here” question with respect to locks.
2. A manager to maintain the set of currently known locks which may come in various lists such as placeholders, ephemerals, auto-deletes, and others. Global lock operations such as removing all ephemeral locks and turning them into placeholder locks, and others. A placeholder, ephemeral, and auto-delete lock may be associated with document component such as a paragraph.
3. The design may not need a lock editor object. The lock objects, once created, may be effectively immutable and there may be no real edit operations to be performed.

A schema lock may also be associated with a document component such as a paragraph. Alternatively, the web browser-based client may have a broader set of features for disallowing coauthoring. Even if the browser client may find a document already open with a schema lock (i.e., another client took the lock), the browser client may need to scan the whole document and allow the user to edit only upon finding no offending features. This may not be an additional burden for the web browser based client since the server application may read nearly the entire document content to transform it to a graph and may abort at any moment.

In another embodiment, seed sync may be used as a request to re-number each paragraph identifier in the document. The request may be issued by putting an element with the same name in the secondary or primary metadata. The re-numbering may be performed as a simple incrementing count starting with the document identifier, and by walking through the paragraphs in the document in a pre-defined order. All subsequent requests and information in the secondary metadata may refer to paragraph identifiers resulting from the re-numbering, not the paragraph identifiers stored in the document originally.

Implementing the seed synchronization request may not be possible in the browser since the re-numbering may depend on parts of the document invisible (currently) to the browser such as headers/footer, footnotes and endnotes, text inside textboxes, and others. The seed synchronization may be implemented in the server front-end.

A simple approach to implementing the sync seed request may be to create a new revision which may change a property (where paragraph identifier is stored) on all paragraphs in the document. A second approach may be to implement a specific request method in the front-end. The method may have a return value of a dictionary mapping an old paragraph identifier to a new identifier. The browser may issue the request when it receives a seed sync element in the secondary metadata and use the resulting map to interpret the remainder of the metadata.

In an alternate embodiment, to keep the server load to a minimum, a light weight request may be implemented to determine whether the user is the single coauthor of the document. A web browser based client may also implement the “am I alone?” request to minimize server load.

A whole sequence is illustrated below as an example embodiment. In the steps below (B) is “the browser”, and (S) is the server (front-end application).
1. (B) Makes a web browser-based service request to get the contents of the file
2. (S) Attempt to Lock the file with a schema lock, and join the session
   a. (S) If the file is already locked with a Schema lock, continue, the user is already not alone.
   b. (S) If the file is locked with any other lock, fail
   c. (S) Issue a request to get current user credentials and server time
3. (S) Retrieves the file (as an Stream) from the store
4. (S) Transforms the stream into a graph (walking through each xml element in the file)
   a. (S) Remember if any element not allowed in a coauthoring session is encountered
5. (S) Adjust the lock
   a. (S) If locked already with a Schema lock
      i. (S) If no issues from step 4a, continue; else attempt to switch to an exclusive lock
   b. (S) Record whether the application ended up a Schema lock or an exclusive lock. Also remember from 2a if the user is already not alone in the document,
6. (S) Stores this graph in the storage, and give the graph a user-specific root. In this fashion, multiple users can all different graph content in the same partition in the storage and not collide with one another. An example would be when two users start with the same document but make different changes. For purposes of storing graphs, their changes must be kept separate until one and then other commit their changes by invoking a Save operation. This root is unique to the user (but not to their browser or computer), such that if the same user boots the application from another computer or another instance of the browser (even after a crash) the system can identify which parts of the graph belong to this user.
7. (S) Sends this graph to the browser
8. (B) Deserializes and displays the content
9. (B) If the application has a Schema lock in step 5c
   a. (B) If alone at the moment (from step 2a) Start a process to ask AmIAlone frequently to determine when/if other authors join
   b. (B) As the user edits, create locks (regardless of whether user was alone or not)
   c. (B) If not alone (from step 2a) or when no longer alone (from 9a above),
      i. (B) Begin displaying any locks created while in this session (step 9b)
      ii. (B) Issue a request to add the current user to the editors' table
      iii. (B) Start repeated processes for editors' table and secondary metadata

New information about additional authors or locks may apply as appropriate to the graph. Once the user leaves the editor, the application may issue a request to remove the current user from the editors table and to leave the coauthoring session.

In yet another embodiment, an implementation may support an “un-editable region.” The complete feature may account for selections that span both editable and un-editable regions, as well as ranges that contain objects other than text, or a mix of text and other objects. The user may need to be able to make selections and place his/her content in un-editable regions to provide a consistent experience with the non-browser based client.

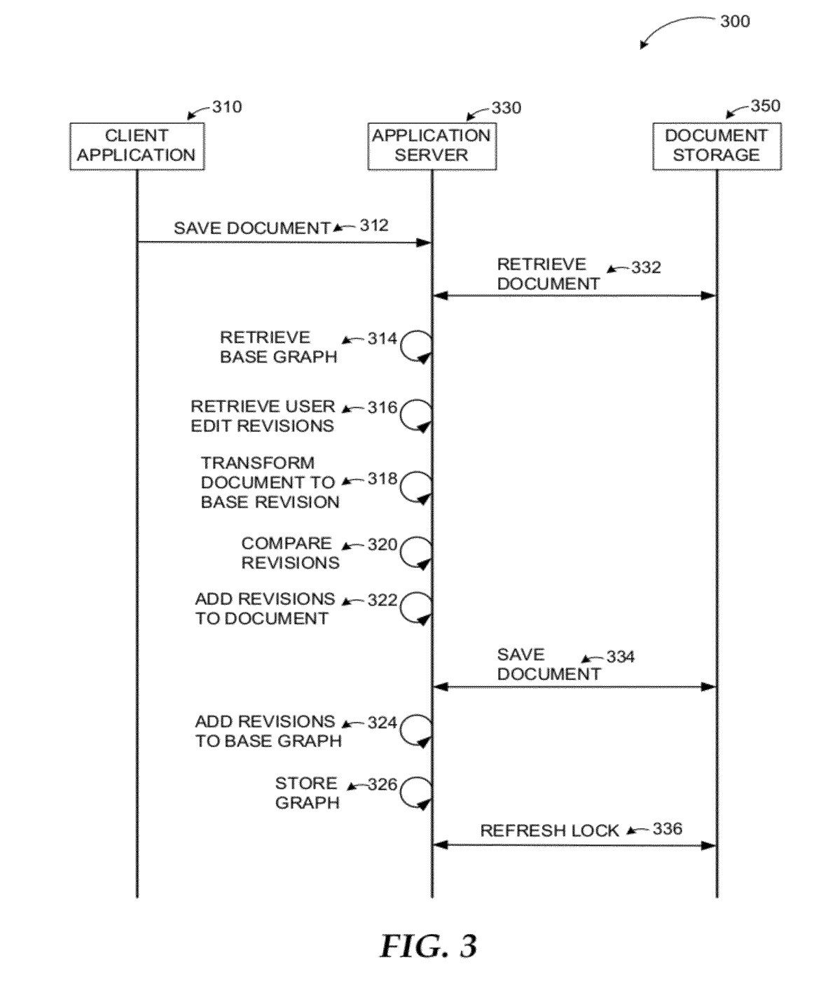

FIG. 3 illustrates an example scenario according to some embodiments. As shown in diagram 300, an application server 310 may provide document editing services. Documents may be of variety of formats including, but not exclusive to, text, drawing, image, audio, and video. An example implementation may be the application server managing coauthored documents for multiple client applications 310 for multiple users. Alternatively, documents may be of single format or may contain a combination of types such as a document combining text, audio and video content.

As shown in diagram 300, client application may make a request to save a document (312) edited by a user. The application server may retrieve document (332) stored in the document storage server 350. At step 314, the application server may retrieve or create the base graph of the document stored locally. At step 316, application server may retrieve a revision of the graph containing the user edits. Then the retrieved document may be transformed to the locally stored base revision (318). Any changes between the base revision and the stored document may be synchronized by the application server. At step 320, the application server may compare revisions between the recently restored base graph to any revisions containing user edits. Edits that can be entered to base graph are prepared for entry into the document at step 322. It should be noted that this may happen even if the document we retrieve in 332 is not the same document as the one that was used to create the graph revision 316. Thus, the coauthoring application does not need to keep a local copy of the “original” document, which improves its ability to scale out (since the application is working against the most up-to-date copy on the server). Changes to the document may be saved to the storage server (334). After saving the changes to the document, the application server may add revisions containing the changes to the base graph. At step 326, the application graph may store the changed graph locally. Any lock holds may be released with a lock refresh at step 336.

In an embodiment, any change may be added to the document in the current session in both non-browser and browser based clients. However, a thick client such as a non-browser based client may obtain the most up to date version of the document from the server during a save action. The user may be asked to resolve any conflicting changes or edits. The user selection may be recorded in the corresponding component in the graph to resolve the conflict. Conflict resolution information sent to the browser based application may include time of the edit, the user's authentication information, the user's presence information, and the user's role. The resulting content may be saved back to the server as the new latest version.

In another embodiment, A high level implementation for merge during a save may include:
1. Obtain a set of changes made by other users (or authors),
2. Compare the changes made by the user to those made by other authors. The server may collect a list of all objects manipulated by both as ‘conflicts’,
3. For all objects considered to be in conflict, the server may determine if the application may resolve the conflict without user intervention. Resolving a conflict may be achieved by manipulating the current user's revisions to represent the desired merged set of changes. If any objects remain unresolved, the server may abort the merge operation and signal the browser to present UI to the user to resolve the conflict,
4. The changes may be applied to the document and saved to storage server, and
5. The application server may send the set of changes from other authors to the browser. Furthermore, if any modifications may be made to the user's own changes in order to resolve a conflict and may send the modifications as well.

Obtaining a set of changes made by other users may still present challenges. The inputs may appear incomplete for managing other users' changes. The current state of the document may be available but the original state may not. However, the application server may know about the original state of the document through the original graph. Changes made by the user may not possibly conflict with changes made by other authors in parts of the document that were not translated into the graph originally. The server application may translate the current state of the document and compare the resulting graph to the original. Comparison may result in a set of changes made by other coauthors to the document. The set of changes may be most naturally represented as a revision, as it may be a difference between two states of the graph. Therefore, the server application may obtain all the information needed to detect conflicts and be able to send the other coauthor's changes to the browser at the end of the merge operation.

Comparing the graph resulting from the current state of the document and the original graph presents its own challenges. One cannot simply use a one-to-one comparison of nodes in the graph, as paragraphs and other objects may have been added or removed or even moved in any arbitrary manner. For constructs in the document to whom a unique identifier of some sort is attached (an example would be paragraphs or table rows), one can use these identifiers to single out the node from the original graph that should correspond to the construct at hand, and compare properties to see if there has been a change. In an example embodiment the system will first read over the entire original graph, building a map from paragraph's identifiers to the graph nodes that represented (the original state of) that object. Then, builds a graph corresponding to the current state of the document. When a node corresponding to a paragraph in this new graph is constructed, the original node is looked up using the paragraph's id. If no such paragraph is found in the map constructed based on the original graph, this paragraph was newly added by other authors. If a node is found in the map, then the properties of the current node are compared with those on the original node. If any properties are added or removed, or if the value of a property is different than the value of the same property on the original node, this paragraph has been changed.

There may be constructs in the document to which a unique identifier is not applied. In order to perform a comparison between current and original, one can rely on other objects near or contained within these constructs to which a unique identifier is associated. For example, a table cell does not have its own unique identifier. However, in this embodiment, the identifier associated with the last paragraph contained in any table cell is used as the identifier for the table (as well as that paragraph itself; since table cell and paragraph node objects are of distinct types, there is no ambiguity in using the same value as the identifier for both). This may require the other parts of the editing system to observe certain rules when modifying such objects so as to not change their identity. In the case of the table cell example, no edit to the cell may change the paragraph identifier of the last paragraph.

Alternatively, in a case where a conflict may not be resolved automatically, a revision containing changes made by other authors may be sent to the browser marked as objects in conflict. Additionally, the same changes may be sent to the browser to bring the user's document up to date. Lastly, the user may be presented with UI to resolve conflicts. The user may try to save again once the all conflicts have been resolved.

An example sequence details performing a merge during a save operation. In the steps below (B) is ‘the browser’, and (S) is ‘the server’ (front-end application).
1. (B) Sends a web browser based service request to save the document,
2. (S) Retrieves the current state of the document (as an IStream) from the storage server,
3. (S) Retrieves the original graph that was stored in storage during load,
4. (S) Retrieves the revision accumulated on the server as the user made edits,
5. (S) Transform the document, using the original from step 3 as a baseline to accumulate a revision of changes made by other users,
6. (S) Compares the revisions from step 4 with the revision from step 5,
   a. (S) If any objects are found in both, tries to resolve by modifying revisions from steps 3 or 4,
   b. (S) If any objects cannot be resolved, aborts the save, returns revision from step 5
7. (S) Runs save with the document and the modified revisions from steps,
8. (S) Stores the resulting document back into the storage server,
9. (S) Adds the revisions from step 5 to the base graph, marks the result as the new base
10. (S) Adds the (possibly modified) revisions from step 6 to the storage
11. (S) Refreshes the lock on the file, and
12. (S) Returns both revision from step 5 and those from step 6 (if modified).

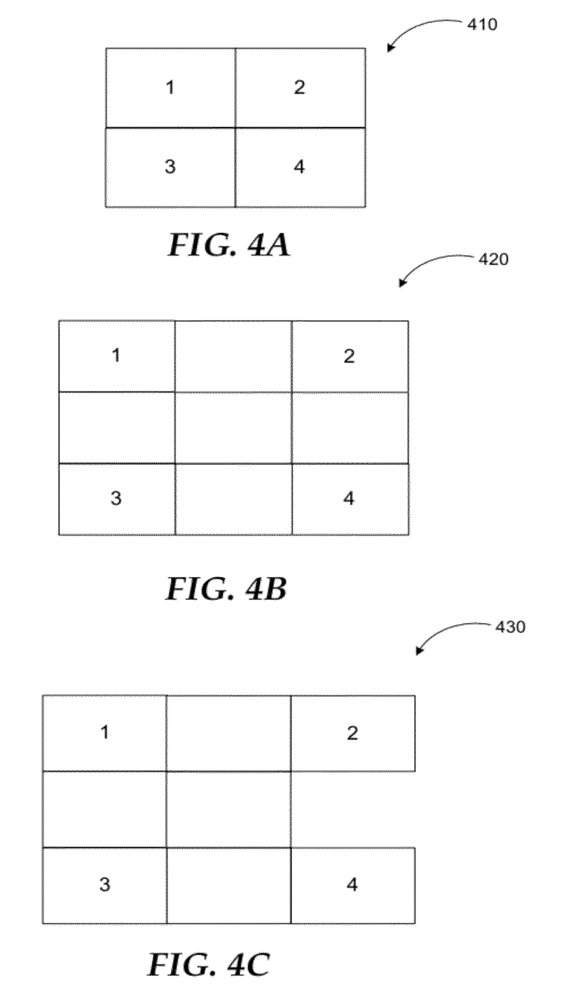

FIG. 4A through 4C illustrate an example scenario according to some embodiments. In an example embodiment, merging structural changes to tables may be complicated when changes may be orthogonal to one another. In diagram 410, a user may start editing a 2×2 table. If the user adds a column in the middle and another user adds a row, the expected result may look like diagram 420. To arrive at the expected result, the server application may need to detect that the added row (added when table had two rows) may need to have a third cell added to it during the merge. Otherwise, added column by the other user may lead to the table in diagram 430 which is missing a cell. This task is made difficult by the fact that columns are not represented as first class objects in neither the document nor graph notations. This complicated situation may arise when one user deletes and adds the same number of columns (appearing that the number of columns has not changed), or when the sum of all coauthors' actions amounts to removing the whole table.

In an alternate embodiment of complicated merge resolutions, a browser based application may have to deal with two authors editing the same paragraph. The browser based application may not attempt to resolve this conflict without user input because it may be undesirable to combine changes at a character level. The application may create meaningless words due to complexity of languages. The next logical unit to break down would be at word processing boundaries. The browser based application may also request user input because unlike paragraphs or rows of a table where two additions or deletions may be understood to be reasonably independent, adding or removing words or sentences from a paragraph may significantly change the content.

In another embodiment of complicated merge resolutions, a browser based application may have to resolve conflicts with lists and renumbering Implementation may be at the top level place in the code of how a browser based application, such as a word processing application, may record and assign numbers to list items. A number for a list item may be calculated and stored (as a non-persistent property) in the graph itself. The number may be updated as list items may be added and deleted or promoted and demoted. Furthermore, in a word processing case, the application may not recalculate these values for all list members in the browser. However, the server application may rather compute the values during a load operation and only incrementally modify as upon user editing actions. If both the user and other coauthors may make non-conflicting changes, (but resulting in numbering of items in the list to change) the server application may need to update the numbers as part of the merge operation.

The systems and implementations of synchronizing online document edits discussed above are for illustration purposes and do not constitute a limitation on embodiments. Documents may be of variety of types including, but not exclusive to, text, drawing, image, audio, and video. Documents may be composed of combination of types. User edits may be synchronized employing other modules, processes, and configurations using the principles discussed herein.

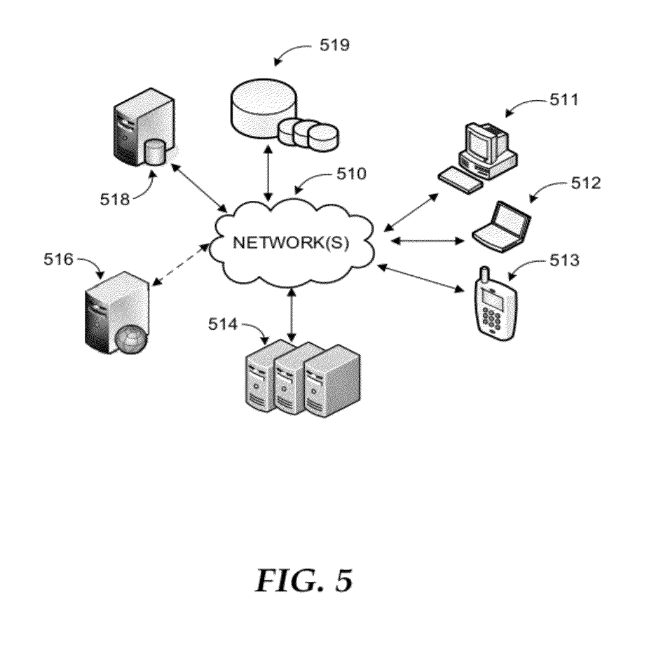

FIG. 5 is an example networked environment, where embodiments may be implemented. A server application managing user edit synchronization may be implemented via software executed over one or more servers 514 or a single server (e.g. web server) 516 such as a hosted service. The platform may communicate with client applications on individual computing devices such as a smart phone 513, a laptop computer 512, or desktop computer 511 (‘client devices’) through network(s) 510.

As discussed above, a document application server may execute the algorithm to synchronize user edits of documents stored in a document storage server. If the user edits components of a document, the application server may transmit information about locked component during user edit to other coauthors editing the document on the client devices 511-513.

Client devices 511-513 may enable access to applications executed on remote server(s) (e.g. one of servers 514) as discussed previously. The server(s) may retrieve or store relevant data from/to data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to synchronize online document edits. Furthermore, the networked environments discussed in FIG. 5 are for illustration purposes only. Embodiments are not limited to the example applications, modules, or processes.

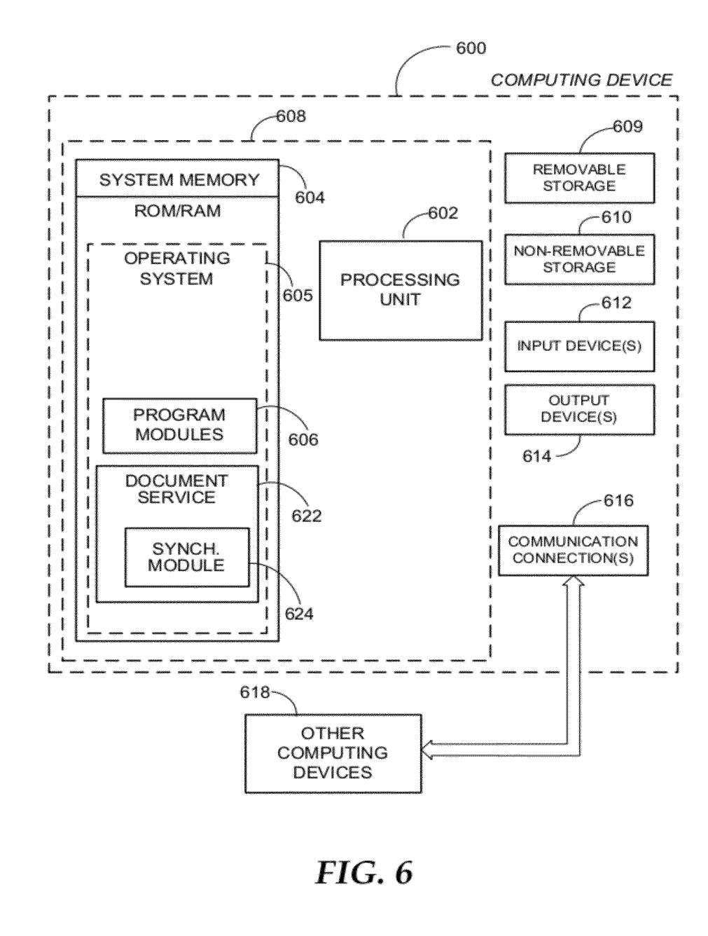

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be an online application server synchronizing user edits for online documents and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, document service 622, and synchronization module 624.

Document service 622 may be part of a service that provides online documents for editing. Synchronization module 624 may synchronize user edits to stored document and resolve conflicts arising from coauthor edits. Document may be broken up to components and components may be stored in a graph for implementing component level locking of document part edits such as paragraphs. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, storage servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

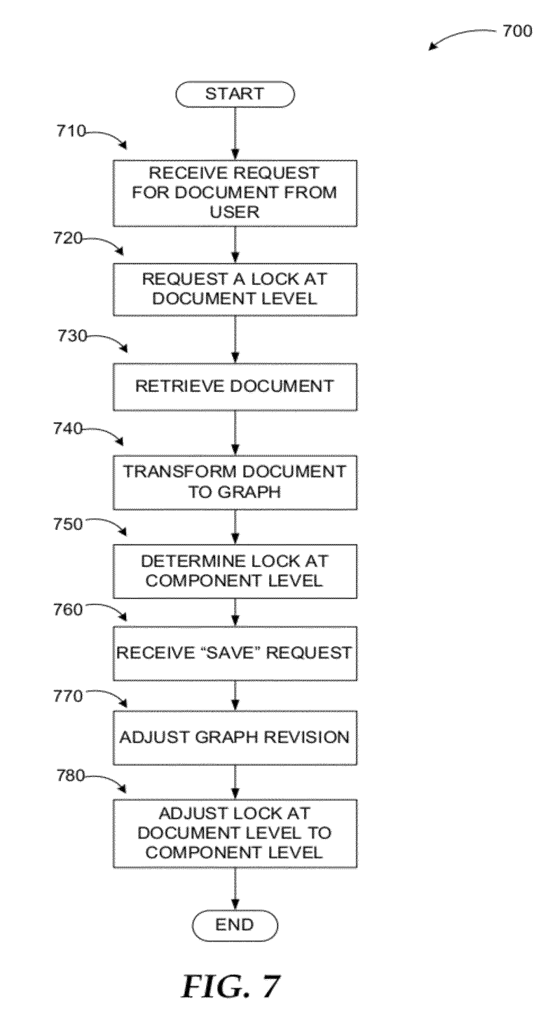

FIG. 7 illustrates a logic flow diagram for process 700 of a process of synchronizing online document edits by controlling revisions at document component level according to embodiments. Process 700 may be implemented by an application server providing online document services to clients.

Process 700 begins with operation 710, where an online document application server (e.g. web server front-end) receives a request for a document from a user. The document may be of a variety of formats. Upon receiving the user request, the application server may request the document to be locked at the storage server at operation 720. After locking the document, the application server may retrieve the document from the storage server at operation 730. The storage server may transmit the document as a stream to the application server. The application server may transform the stream to document components and load the components to a graph at operation 740. The server may compare the graph revision containing the retrieved document to the locally stored base graph and synchronize any changes in the components.

At operation 750, the application server may determine which document components the user may have made changes to. At operation 760, a save operation may be performed upon a user invoking the save operation and the application server may determine which components of the graph to lock based on the user changes and record the changes to corresponding components while creating a new revision of the graph at subsequent operation 770. The application server may modify the document lock with a component based lock on the local graph to prevent concurrent user edits on the currently worked components at operation 780. The client application may display notices showing which components of the document may be locked or being worked on by a user. The provided information may also contain user presence information, and author name to indicate the current author of the component. Furthermore, a document level lock may also be displayed to the user. Additionally, presence information of the coauthors may be stored in the component of the graph in which the coauthor made the last edit. The coauthor's presence information may be displayed by the client application with the edited component.

Upon receiving the metadata indicating other authors' presence in the document, the current user is prevented from further modifications of the locked component. If/when the other author saves to commit his/her changes, any locks held by them previously may be removed and instead turned into “refresh required” locks. This lock has a different appearance and is no longer associated with the other author.

Conversely, when the current user does perform an edit action, the presence of our current author may be communicated to other authors (if any) by adding to the metadata describing presence of in-document locks. When the current user saves their changes, a request may be sent to the server to remove any locks held by the current user and instead turn them into “refresh required” locks for everyone else.

The operations included in process 700 are for illustration purposes. Synchronizing online document edits according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part by a computing device for synchronizing online document edits, the method comprising:
receiving an indication of a first coauthoring metadata associated with a first section of a document, the first coauthoring metadata received from a browser-based client application;
receiving an indication of a second coauthoring metadata associated with a second section of the document, the second coauthoring metadata received from a second client application, the second client application not operating in a browser;
translating the first coauthoring metadata based on a transformed representation provided to the browser-based client application; and
storing the first coauthoring metadata and the second coauthoring metadata in association with the document.

2. The method of claim 1, wherein the first coauthoring metadata includes at least one from a set of: a user's name, the user's presence information, and an in-document lock.

3. The method of claim 1, further comprising:
upon receiving the second coauthoring metadata indicating another authors' presence in the document, preventing a current user from further modifications of a locked component.

4. The method of claim 1, wherein the first section of the document is a paragraph and the first coauthoring metadata includes an ephemeral lock associated with the paragraph.

5. The method of claim 1, further comprising:
recognizing one or more edits that conflict with other edits in a changed document at a component level.

6. The method of claim 5, further comprising:
attempting to merge conflicting edits within the same component without notification, if the conflicting edits are complimentary.

7. The method of claim 1, wherein the client application is a browser based client application and the request for the document is sent from a script executing on the client application.

8. The method of claim 1, further comprising:
re-numbering each paragraph of the document upon receiving a request from the client application to ensure paragraph number synchronization among clients accessing the document.

9. The method of claim 1, further comprising:
sending a request to the a server executing a coauthoring application associated with the document to determine whether the user is a single coauthor of the document.

10. The method of claim 1, wherein the client application is one of: a word processing application, a spreadsheet application, a presentation application, and a scheduling application.

11. An online document application server for synchronizing online document edits, the server comprising:
a memory;
a processor coupled to the memory, the processor executing an application in conjunction with instructions stored in the memory, wherein the application is configured to:
receive a request for a document from a user;
request a document lock for the document from a storage server;
retrieve the document from the storage server;
transform the document to a plurality of components comprising contents of the document and a first coauthoring metadata including a user's name and a user's presence information;
determine a conflict between edits by at least two users;
determine a plurality of component locks for the plurality of components by evaluating the conflicting edits;
adjust the document lock to the plurality of component locks by releasing the document lock, applying the plurality of component locks to matching components; and
send the graph to a browser based client application for display.

12. The application server of claim 11, wherein upon determining the conflict, the application is further configured to:
send at least one conflicting user edit and at least one corresponding component to the browser based client application for at least one user selection, wherein the at least one user selection is recorded in the at least one corresponding component to resolve the conflict.

13. The application server of claim 11, wherein the application is further configured to:
store the plurality of component locks as second coauthoring metadata in a document graph.

14. The application server of claim 13, wherein an offline browser based client application transmits the at least one user edit for integration into the document graph after coming back online.

15. The application server of claim 11, wherein the application further configured to:
send at least one from a set of: an edit time, a user's authentication information, and a user's role to the browser based client application.

16. The application server of claim 11, wherein the document includes at least one from a set of: a text, an image, a drawing, audio data, and video data.

17. A computer-readable storage medium with instructions stored thereon for synchronizing online document edits, the instructions comprising:
receiving a request for a document from a user;
requesting a document lock for the document from a storage server;
retrieving the document from the storage server;
transforming the document to a plurality of components comprising a first coauthoring metadata including a user's name and a user's presence information and storing the plurality of components in a graph;
determining a plurality of component locks for the plurality of components by evaluating an at least one user edit;
adjusting the document lock to the plurality of component locks by releasing the document lock, applying the plurality of component locks to matching components in the graph, and storing the plurality of component locks as a second coauthoring metadata in the graph; and
sending the graph to a browser based client application for display.

18. The computer-readable storage medium of claim 17, wherein the instructions further comprise:
notifying a current user of the plurality of component locks.

19. The computer-readable storage medium of claim 17, wherein the instructions further comprise:
storing component level identifiers; and
moving a user's edits to proper component regions using the component level identifiers, even if other parts of the document have changed.

20. The computer-readable storage medium of claim 17, wherein the instructions further comprise:
notifying a user of a name and a presence information of a current author editing the document.
